(19) United States
(12) Patent Application Publication
(10) Pub. No.: US 2023/0107060 A1
(43) Pub. Date: Apr. 6, 2023

(54) VEHICLE DISPLAY CONTROL DEVICE AND VEHICLE DISPLAY CONTROL METHOD

(71) Applicant: Panasonic Intellectual Property Management Co., Ltd., Osaka (JP)

(72) Inventors: Taiki TAKAAZE, OSAKA FU (JP); Asuka EGASHIRA, EHIME KEN (JP); Seigo TAKADA, OSAKA FU (JP); Hirokazu TOKUDA, OSAKA FU (JP); Hiroshi TAKEKAWA, OSAKA FU (JP); Masato NOGUCHI, NARA KEN (JP); Kyouji TANAKA, OSAKA FU (JP)

(73) Assignee: Panasonic Intellectual Property Management Co., Ltd., Osaka (JP)

(21) Appl. No.: 17/897,809

(22) Filed: Aug. 29, 2022

(30) Foreign Application Priority Data
Sep. 28, 2021 (JP) 2021-158008

(51) Int. Cl. B60K 35/00

(52) U.S. Cl. CPC B60K 35/00; B60K 2370/169; B60K 2370/1868; B60K 2370/52

(57) ABSTRACT

A vehicle display control device includes a hardware processor functioning as a regulation recognition unit, a regulation validity determination unit, and a display controller. The regulation recognition unit serves to recognize a traffic regulation mark indicating a traffic regulation provided on a traveling route of a host vehicle. The regulation validity determination unit serves to determine whether or not regulation content information is valid. The regulation content information is content of the regulation indicated by the traffic regulation mark recognized by the regulation recognition unit. The display controller serves to control a display device mounted on the host vehicle to display the regulation content information in a display region. The display controller changes a display mode of the regulation content information in response to determining by the regulation validity determination unit that the regulation content information is not valid.

### CROSS-REFERENCE TO RELATED APPLICATIONS

This application is based upon and claims the benefit of priority from Japanese Patent Application No. 2021-158008, filed on Sep. 28, 2021, the entire contents of which are incorporated herein by reference.

### FIELD

The present disclosure relates generally to a vehicle display control device and a vehicle display control method.

### BACKGROUND

There has been known a vehicle display control device that displays contents of regulation indicated by a traffic regulation mark. In such a device, when a host vehicle has entered a valid range of a regulation indicated by a traffic regulation mark, the vehicle display control device displays, in a display region, remaining amount information 20 indicating a remaining amount identified by a remaining amount identification unit, in addition to regulation content information indicating contents of the regulation in the valid range (for example, JP 2020-047289 A). In addition, the display region in which the remaining amount information is displayed is switched in accordance with a situation of the host vehicle with respect to the valid range (for example, JP 2020-047289 A).

However, in a case where the regulation content information is not valid, there is a possibility that the regulation content information cannot be appropriately displayed.

### SUMMARY

A vehicle display control device according to the present disclosure includes a hardware processor functioning as a regulation recognition unit, a regulation validity determination unit, and a display controller. The regulation recognition unit serves to recognize a traffic regulation mark indicating a traffic regulation provided on a traveling route of a host vehicle. The regulation validity determination unit serves to determine whether or not regulation content information is valid. The regulation content information is content of the regulation indicated by the traffic regulation mark recognized by the regulation recognition unit. The display controller serves to control a display device mounted on the host vehicle to display the regulation content information in a display region. The display controller changes a display mode of the regulation content information in response to determining by the regulation validity determination unit that the regulation content information is not valid.

A vehicle display control method according to the present disclosure includes: recognizing a traffic regulation mark indicating a traffic regulation provided on a traveling route of a host vehicle; determining whether or not regulation content information is valid, the regulation content information being content of the regulation indicated by the recognized traffic regulation mark; and controlling a display device mounted on the host vehicle to display the regulation content information in a display region. The controlling of the display device includes changing a display mode of the regulation content information in response to determining by the determination that the regulation content information is not valid.

### BRIEF DESCRIPTION OF THE DRAWINGS

FIG. 1 is a diagram illustrating an example of a configuration of a vehicle system according to an embodiment;

FIG. 2 is a block diagram illustrating an example of a functional configuration of a vehicle display control device according to the embodiment;

FIG. 3 is a view illustrating an example of display of regulation content information in a case where the regulation content information is not valid;

FIG. 4 is a view illustrating another example of the display of the regulation content information in a case where the regulation content information is not valid;

FIG. 5 is a flowchart illustrating an example of regulation display control-related processing of the vehicle display control device according to the embodiment;

FIG. 6 is a schematic diagram illustrating an example of a situation of a host vehicle with respect to a regulation valid range:

FIG. 7 is a view illustrating an example of display of the regulation content information and remaining amount information in a proximal display region and a distal display region at a vehicle position P1 in FIG. 6:

FIG. 8 is a view illustrating another example of the display of the regulation content information and the remaining amount information in the proximal display region and the distal display region at the vehicle position P1 in FIG. 6;

FIG. 9 is a view illustrating an example of display of the regulation content information and the remaining amount information in the proximal display region and the distal display region at a vehicle position P2 in FIG. 6;

FIG. 10 is a view illustrating an example of display of the regulation content information and the remaining amount information in the proximal display region and the distal display region at a vehicle position P3 in FIG. 6;

FIG. 11 is a schematic diagram illustrating another example of the situation of the host vehicle with respect to the regulation valid range;

FIG. 12 is a view illustrating an example of display of the regulation content information and the remaining amount information in the proximal display region and the distal display region at a vehicle position P11 in FIG. 11;

FIG. 13 is a view illustrating an example of display of the regulation content information and the remaining amount information in the proximal display region and the distal display region at a vehicle position P12 in FIG. 11;

FIG. 14 is a view illustrating an example of display of the regulation content information and the remaining amount information in the proximal display region and the distal display region at a vehicle position P13 in FIG. 11;

FIG. 15 is a view illustrating an example of display of the regulation content information and the remaining amount information in the proximal display region and the distal display region at a vehicle position P14 in FIG. 11;

FIG. 16 is a view illustrating an example of display of the regulation content information and the remaining amount information in the proximal display region and the distal display region at a vehicle position P15 in FIG. 11;

FIG. 17 is a view illustrating an example of display of the regulation content information and the remaining amount information in the proximal display region and the distal display region at a vehicle position P16 in FIG. 11;

FIG. 18 is a view illustrating an example of display of the regulation content information and the remaining amount information in the proximal display region and the distal display region at a vehicle position P17 in FIG. 11;

FIG. 19 is a view illustrating another example of the display of the regulation content information and the remaining amount information in the proximal display region and the distal display region at the vehicle position P14 in FIG. 11;

FIG. 20 is a view illustrating another example of the display of the regulation content information and the remaining amount information in the proximal display region and the distal display region at the vehicle position P14 in FIG. 11;

FIG. 21 is a view illustrating another example of the display of the regulation content information and the remaining amount information in the proximal display region and the distal display region according to a traveling situation of the host vehicle; and

FIG. 22 is a hardware configuration diagram of the vehicle display control device.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that the accompanying drawings and the following description are provided for those skilled in the art to fully understand the present disclosure, and are not intended to limit the subject matter described in the claims.

### Embodiment

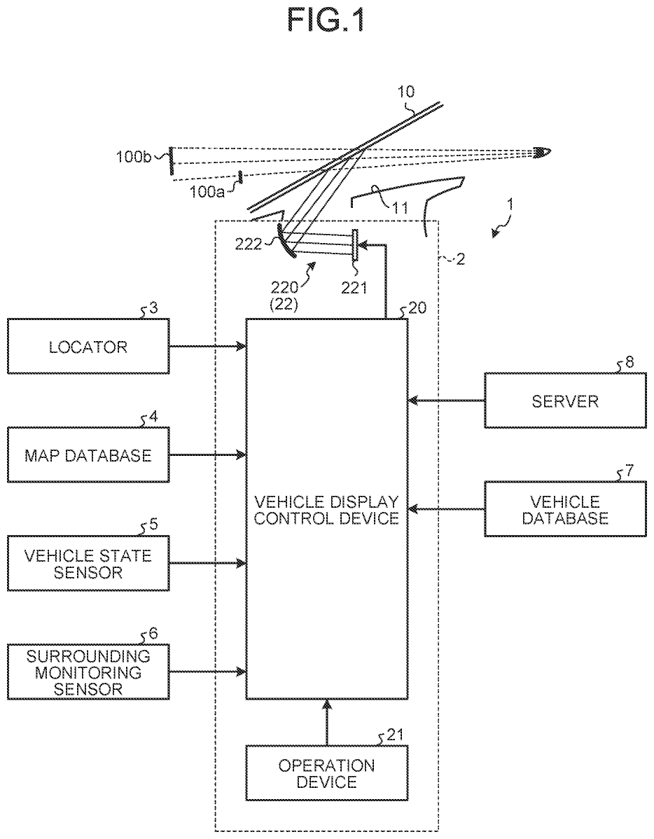

An embodiment will be described below with reference to FIGS. 1 to 22.

Schematic Configuration of Vehicle System 1

First, a configuration of a vehicle system 1 according to the present embodiment will be described with reference to FIG. 1. FIG. 1 is a diagram illustrating an example of the configuration of the vehicle system 1 according to the embodiment.

The vehicle system 1 is used in a vehicle, such as an automobile, and includes a human machine interface (HMI) system 2, a locator 3, a map database 4, a vehicle state sensor 5, a surrounding monitoring sensor 6, a vehicle database 7, and a server 8. It is assumed that the HMI system 2, the locator 3, the map database 4, the vehicle state sensor 5, the surrounding monitoring sensor 6, the vehicle database 7, and the server 8 are connected to, for example, an in-vehicle local area network (LAN). Hereinafter, a vehicle using the vehicle system 1 is referred to as a host vehicle.

The locator 3 includes a global navigation satellite system (GNSS) receiver (not illustrated) and an inertial sensor (not illustrated). The GNSS receiver receives positioning signals from a plurality of artificial satellites. The inertial sensor includes, for example, a three-axis gyro sensor and a three-axis acceleration sensor. The locator 3 sequentially measures a vehicle position of the host vehicle on which the locator 3 is mounted by combining the positioning signal received by the GNSS receiver and a measurement result of the inertial sensor. Note that the locator 3 may measure the vehicle position of the host vehicle by using a traveling distance obtained from signals sequentially output from a vehicle speed sensor mounted on the host vehicle.

The map database 4 is a nonvolatile memory and stores map data such as link data and node data. The link data includes data such as a link ID for specifying a link, a link length indicating a length of the link, a link orientation, a link traveling time, link shape information, node coordinates (latitude/longitude) of a start point and an end point of the link, and a road attribute. It is assumed that the road attribute data includes, for example, data regarding a regulation indicated by a traffic regulation mark being a road sign and/or a road marking (hereinafter, referred to as regulation data). Examples of the regulation include speed limits, parking prohibition, passing prohibition, and vehicle crossing prohibition.

In addition, the traffic regulation mark also includes a sign (supplementary sign) that supplements the regulation data, and the road attribute data also includes data of the supplementary sign (hereinafter, referred to as supplementary data). Examples of the supplementary data include data specifying a vehicle type to be regulated (hereinafter, referred to as vehicle type specifying data), data specifying a date or a time zone to which the regulation is applied (hereinafter, referred to as time specifying data), data specifying a length and a region range to which the regulation is applied (hereinafter, referred to as valid range data), and data specifying a vehicle traveling condition in a traveling environment to be regulated (hereinafter, referred to as vehicle traveling condition data). Note that the regulation data and the supplementary data may be stored in the map database 4 as data other than the link data. The node data includes data such as a node ID which is a unique number assigned for each node on a map, node coordinates, a node name, a node type, a connection link ID in which a link ID of a link connected to a node is described, and an intersection type.

The vehicle state sensor 5 is a sensor group for detecting a traveling state of the host vehicle. Examples of the vehicle state sensor 5 include a vehicle speed sensor that detects a vehicle speed of the host vehicle. The vehicle state sensor 5 outputs a detection result to the in-vehicle LAN. Note that the detection result of the vehicle state sensor 5 may be output to the in-vehicle LAN via an electronic control unit (ECU) mounted on the host vehicle.

The surrounding monitoring sensor 6 recognizes a traveling environment of the host vehicle. The surrounding monitoring sensor 6 detects an obstacle such as a stationary object or a moving object around the host vehicle, and detects a road sign or a road marking such as a lane marking. A front camera having a predetermined range in front of the host vehicle as an imaging range may be used as the surrounding monitoring sensor 6. For example, the front camera may be provided in a rearview mirror of the host vehicle. Note that the front camera may be provided, for example, on an upper surface of an instrument panel 11 of the host vehicle. As the surrounding monitoring sensor 6, a camera that captures an image of a region other than a region in front of the host vehicle may be used, or a millimeter-wave radar, sonar, light detection and ranging (LiDAR), or the like may be used.

The vehicle database 7 is a nonvolatile memory, and stores vehicle data such as a vehicle type, a weight, a height, and a length of the host vehicle, and time data such as date and time. The vehicle type of the host vehicle is, for example, an “ordinary-sized passenger motor vehicle”, a “large freight motor vehicle”, a “large special motor vehicle”, or the like. The date and time information may be automatically adjusted by radio waves of a global positioning system (GPS), or may be manually adjusted.

The HMI system 2 includes a vehicle display control device 20, an operation device 21, and a display device 22, and receives an input operation from a driver of the host vehicle and presents information to the driver of the host vehicle. The operation device 21 is a group of switches operated by the driver of the host vehicle. The operation device 21 is used to perform various settings. Examples of the operation device 21 include a steering switch provided on a spoke portion of the steering of the host vehicle. Note that the driver is an example of a “user” in the claims.

The display device 22 presents information to the driver by displaying information on the basis of an instruction from the vehicle display control device 20. Examples of the display device 22 include a head-up display (HUD) 220, a combination meter, a center information display (CID), and the like. The HUD 220 projects light of a display image based on image data acquired from the vehicle display control device 20 onto a projection region in front of a driver's seat of the host vehicle, thereby displaying a virtual image of the display image to superimpose on part of a foreground so that the driver can visually recognize the virtual image. The combination meter and the CID display information by, for example, a liquid crystal display. The combination meter is disposed in the instrument panel 11 in front of the driver's seat. The CID is disposed above a center cluster.

In the present embodiment, in particular, a case where the HUD 220 is used as the display device 22 will be described as an example. The HUD 220 is capable of displaying a virtual image of each display image so that the driver can visually recognize the virtual image by projecting the display image onto each of two projection regions positioned at different positions.

As illustrated in FIG. 1, the HUD 220 is provided in the instrument panel 11 of the host vehicle. The HUD 220 projects a display image formed by, for example, a liquid crystal projector or scanning projector 221 onto a predetermined projection region of a windshield 10 as a projection member through an optical system 222 such as a concave mirror. The projector 221 projects a plurality of display images onto two projection regions positioned at different positions by different optical paths. A light flux of the display image reflected toward a vehicle interior by the windshield 10 is perceived by the driver seated on the driver's seat. The driver seated on the driver's seat also perceives a light flux from the foreground as a landscape present in front of the host vehicle, the light flux having passed through the windshield 10 formed of translucent glass. Therefore, the driver can visually recognize virtual images 100a and 100b of the plurality of display images formed in front of the windshield 10, the virtual images 100a and 100b being superimposed on part of the foreground. That is, the HUD 220 displays the virtual images 100a and 100b in a form in which the virtual images 100a and 100b are superimposed on the foreground of the host vehicle to implement so-called augmented reality (AR) display. Note that the projection member on which the HUD 220 projects the display image is not limited to the windshield 10, and may be a translucent combiner or the like.

As illustrated in FIG. 1, the virtual images displayed by the HUD 220 include a proximal virtual image 100a and a distal virtual image 100b. Each of a range in which the proximal virtual image 100a can be displayed (hereinafter, referred to as a proximal display region) and a range in which the distal virtual image 100b can be displayed (hereinafter, referred to as a distal display region) has a horizontally long rectangular shape in which sides in a vehicle width direction are longer. The size of the distal display region is set to be larger than the size of the proximal display region.

In addition, the proximal virtual image 100a and the distal virtual image 100b are formed at different positions in a front-rear direction of the host vehicle when visually recognized by the driver. The proximal virtual image 100a is formed closer to the windshield 10 than the distal virtual image 100b is. Moreover, the proximal virtual image 100a and the distal virtual image 100b are also formed at positions misaligned in a top-bottom direction when visually recognized by the driver. In other words, the proximal virtual image 100a and the distal virtual image 100b are also formed at positions misaligned in a vertical direction. Specifically, a position at which the proximal virtual image 100a is formed is set to be lower than a position at which the distal virtual image 100b is formed. In addition, it is preferable that the position at which the distal virtual image 100b is formed is set to be on approximately the same level as an eye point of the driver when visually recognized by the driver, for example, as illustrated in FIG. 1.

Note that, when visually recognized by the driver, a lower edge portion of the distal virtual image 100b may be positioned on a level lower than that of an upper edge portion of the proximal virtual image 100a. For example, the distal display region may have a partially cut-away rectangular shape so as to avoid the proximal display region. In addition, a lower side of the distal display region and an upper side of the proximal display region may be separated in the top-bottom direction.

The vehicle display control device 20 mainly includes a microcomputer including a processor, a computer-readable non-transitory recording medium such as a volatile memory and a nonvolatile memory, an I/O, and a bus that connects these components. The vehicle display control device 20 is connected to the operation device 21, the display device 22, and the in-vehicle LAN. The vehicle display control device 20 performs various processing by executing a control program stored in the nonvolatile memory. For example, the vehicle display control device 20 controls the display performed by the HUD 220. Note that a functional configuration of the vehicle display control device 20 related to the control of the display performed by the HUD 220 will be described in detail later.

Schematic Configuration of Vehicle Display Control Device 20

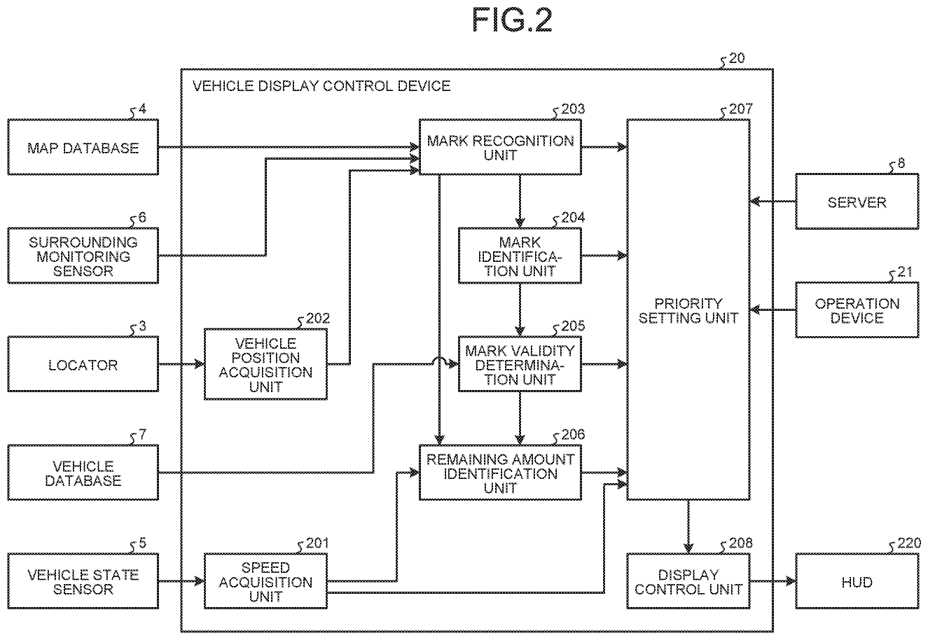

Next, a functional configuration of the vehicle display control device 20 according to the present embodiment will be described with reference to FIG. 2. FIG. 2 is a block diagram illustrating an example of the functional configuration of the vehicle display control device 20 according to the embodiment.

As illustrated in FIG. 2, the vehicle display control device 20 functions as a speed acquisition unit 201, a vehicle position acquisition unit 202, a mark recognition unit 203, a mark identification unit 204, a mark validity determination unit 205, a remaining amount identification unit 206, a priority setting unit 207, and a display control unit (or controller) 208, for the control of the display performed by the HUD 220. Note that part of or all the functions executed by the vehicle display control device 20 may be configured as hardware by one or more ICs or the like. Part of or all the functions of the vehicle display control device 20 may be implemented by a combination of execution of software by a hardware processor and hardware members.

The speed acquisition unit 201 acquires the speed of the host vehicle from the vehicle speed sensor among the vehicle state sensors 5. The vehicle position acquisition unit 202 acquires the vehicle position of the host vehicle measured by the locator 3. The mark recognition unit 203 recognizes a traffic regulation mark present in front of the host vehicle in a traveling direction, and the mark identification unit 204 identifies a vehicle type (hereinafter, referred to as a regulation target vehicle type) that is a regulation target, a day or a time zone to which the regulation is applied (hereinafter, referred to as a regulation application time), a valid range of the regulation (hereinafter, referred to as a regulation valid range), and the like indicated by the traffic regulation mark. Note that, in a case where the traffic regulation mark indicates the weight, height, or length of the vehicle that is a regulation target, a vehicle having the corresponding weight, height, or length is also included in the regulation target vehicle type.

The mark recognition unit 203 determines whether or not the regulation data and/or the supplementary data, each being associated with the link present in front of the host vehicle in the traveling direction, is present on the basis of the vehicle position of the host vehicle acquired by the vehicle position acquisition unit 202 and the above-described regulation data and supplementary data of the map data stored in the map database 4. In a case where at least one of the regulation data and the supplementary data associated with the link present in front of the host vehicle in the traveling direction is present, the mark recognition unit 203 recognizes a traffic regulation mark indicated by at least one of the regulation data and the supplementary data as the traffic regulation mark present in front of the host vehicle in the traveling direction. The mark recognition unit 203 corresponds to a “regulation recognition unit” in the claims.

In addition, the mark recognition unit 203 recognizes the traveling environment of the host vehicle from the detection result of the surrounding monitoring sensor 6. For example, the mark recognition unit 203 recognizes a traffic regulation mark or recognizes the presence or absence of a preceding vehicle from a captured image acquired from a front camera (hereinafter, referred to as a front image) by image recognition processing such as pattern matching.

The recognition of the traffic regulation mark by the mark recognition unit 203 includes recognition of content of a supplementary sign in the traffic regulation mark in addition to content of a regulation indicated by the traffic regulation mark. The content of the supplementary sign may be recognized by using pattern matching or a character string detection technology. In a case where the traffic regulation mark can be recognized from the front image, the mark recognition unit 203 may recognize the traffic regulation mark as a traffic regulation mark present in front of the host vehicle in the traveling direction.

In a case where the mark recognition unit 203 has recognized the traffic regulation mark present in front of the host vehicle in the traveling direction, the mark identification unit 204 identifies the regulation target vehicle type, the regulation application time, and the regulation valid range indicated by the traffic regulation mark. Therefore, the mark identification unit 204 corresponds to a “first regulation identification unit” and a “second regulation identification unit” in the claims.

The mark identification unit 204 may be configured to identify the regulation target vehicle type, the regulation application time, and the regulation valid range from the supplementary data including the vehicle type specifying data, the time specifying data, and the valid range data described above among the map data stored in the map database 4. In addition, the mark identification unit 204 may be configured to identify the regulation target vehicle type, the regulation application time, and the regulation valid range from the content of the supplementary sign in a case where the content of the supplementary sign of the traffic regulation mark is recognized from the front image acquired from the front camera by the mark recognition unit 203. For example, in a case where the content of the supplementary sign such as “large freight motor vehicle” is recognized by the mark recognition unit 203, the mark identification unit 204 identifies a large freight motor vehicle as the regulation target vehicle type. In addition, in a case where the content of the supplementary sign such as “8-20” is recognized, the mark identification unit 204 identifies a time zone from 8:00 AM to 8:00 PM as the time zone to which the regulation is applied. In addition, in a case where the content of the supplementary sign such as “100 m from here” is recognized, the mark identification unit 204 may identify 100 m as the regulation valid range.

The mark validity determination unit 205 determines whether or not the traffic regulation mark is valid, on the basis of the regulation target vehicle type and the regulation application time indicated by the traffic regulation mark and identified by the mark identification unit 204. That is, the mark validity determination unit 205 determines whether or not the traffic regulation mark is a traffic regulation mark applied to the host vehicle. Therefore, the mark validity determination unit 205 corresponds to a “regulation validity determination unit” in the claims. The mark validity determination unit 205 determines whether or not the traffic regulation mark is valid in consideration of the regulation target vehicle type and the regulation application time identified by the mark identification unit 204 and vehicle information and date and time information included in the vehicle database 7.

For example, in a case where the mark identification unit 204 recognizes the content of the supplementary sign such as “large freight motor vehicle” indicating the regulation target vehicle type, the mark validity determination unit 205 determines that the traffic regulation mark is valid in a case where the host vehicle is a large freight motor vehicle, by referring to the vehicle information included in the vehicle database 7. On the other hand, in a case where the host vehicle is not a large freight motor vehicle, the mark validity determination unit 205 determines that the traffic regulation mark is not valid.

In addition, in a case where the mark identification unit 204 recognizes the content of the supplementary sign such as “8-20” indicating the regulation application time, the mark validity determination unit 205 determines that the traffic regulation mark is valid in a case where the current time is between 8:00 AM and 8:00 PM, by referring to the date and time information included in the vehicle database 7. On the other hand, in a case where the current time is not between 8:00 AM and 8:00 PM, that is, in a case where the current time is between 8:00 PM on today and 8:00 AM on the next day, the mark validity determination unit 205 determines that the traffic regulation mark is not valid.

The remaining amount identification unit 206 identifies a remaining amount required for the host vehicle to travel from the vehicle position of the host vehicle to a start position of the regulation valid range (hereinafter, referred to as a start remaining amount), and identifies a remaining amount required for the host vehicle to travel from the vehicle position of the host vehicle to an end position of the regulation valid range (hereinafter, referred to as an end remaining amount). As an example, the remaining amount identification unit 206 identifies the start remaining amount in a case where a distance from the vehicle position of the host vehicle to the start position of the regulation valid range is equal to or less than a set value that can be optionally set. The distance from the vehicle position of the host vehicle to the start position of the regulation valid range may be calculated from the vehicle position of the host vehicle acquired by the vehicle position acquisition unit 202 and the map data stored in the map database 4. Alternatively, the remaining amount identification unit 206 may use a distance from the host vehicle to the start position of the regulation valid range identified by the mark identification unit 204. In this case, the remaining amount identification unit 206 may identify the start position of the regulation valid range from the fact that the mark identification unit 204 has recognized the content of the supplementary sign such as “start” indicating the start position of the regulation valid range. Note that the remaining amount identification unit 206 may be configured to sequentially identify the start remaining amount until the host vehicle enters the regulation valid range, or may be configured to identify the start remaining amount once when the distance from the vehicle position of the host vehicle to the start position of the regulation valid range has become equal to or less than the set value that can be optionally set.

In addition, the remaining amount identification unit 206 may start identifying the end remaining amount when the host vehicle has entered the regulation valid range. The remaining amount identification unit 206 may determine that the host vehicle has entered the regulation valid range from the fact that the mark identification unit 204 has identified the content of the supplementary sign such as “start” indicating the start position of the regulation valid range. In addition, the remaining amount identification unit 206 may determine that the host vehicle has entered the regulation valid range on the basis of the vehicle position of the host vehicle and the valid range data of the map data. As an example, the remaining amount identification unit 206 may be configured to sequentially identify the end remaining amount for the regulation valid range up to the end position of the target regulation valid range. The remaining amount identification unit 206 may determine the end position of the regulation valid range from the fact that the mark identification unit 204 has identified the content of the supplementary sign such as “end” indicating the end position of the regulation valid range, or may determine the end position of the regulation valid range from the fact that the identified remaining amount has become zero.

In a case of identifying a remaining traveling distance as the start remaining amount, the remaining amount identification unit 206 may identify a traveling distance from the vehicle position of the host vehicle to the start position of the regulation valid range as the remaining traveling distance. On the other hand, in a case of identifying the remaining traveling distance as the end remaining amount, the remaining amount identification unit 206 may identify the remaining traveling distance by subtracting a traveling distance after the host vehicle enters the regulation valid range from a distance corresponding to the regulation valid range.

The remaining amount identification unit 206 may identify a remaining traveling time as the start remaining amount or the remaining traveling time as the end remaining amount by dividing the above-described remaining traveling distance by the speed of the host vehicle acquired by the speed acquisition unit 201. As the speed of the host vehicle, an average speed in a predetermined period that can be optionally set may be used.

The priority setting unit 207 sets priority of the traffic regulation mark in a case where the host vehicle is positioned within the regulation valid range indicated by the traffic regulation mark. In other words, the priority setting unit 207 specifies the priority of the valid traffic regulation mark for which the host vehicle is positioned within the regulation valid range.

As an example, the priority setting unit 207 may be configured to set the priority of the traffic regulation mark in accordance with the situation of the host vehicle with respect to the regulation valid range. Specifically, the priority setting unit 207 may be configured to place higher priority on the traffic regulation mark with respect to the regulation valid range for which the remaining amount identified by the remaining amount identification unit 206 is small. In addition, the priority setting unit 207 may be configured to perform setting in accordance with selection received from the driver via the operation device 21.

Note that the selection from the driver may be received via a microphone in a case where a speech recognition unit is used in the host vehicle. In addition, the priority setting unit 207 may be configured to set the priority of the traffic regulation mark in accordance with the type of the traffic regulation mark. In this case, a correspondence relation between the type of the traffic regulation mark and the priority may be stored in advance in the nonvolatile memory of the vehicle display control device 20, and the priority setting unit 207 may set the priority of the traffic regulation mark by referring to the correspondence relation.

In addition, the priority setting unit 207 may be configured to set the priority of the traffic regulation mark in accordance with the determination result of the mark validity determination unit 205. Specifically, the priority setting unit 207 may be configured to place the lowest priority on a traffic regulation mark that has been determined as being not valid by the mark validity determination unit 205. For example, in a case of setting four levels of priority with the highest priority being 3 and the lowest priority being 0 as the priority of the traffic regulation mark, the priority setting unit 207 sets, to 0 being the lowest priority, the priority of the traffic regulation mark having been determined as being not valid by the mark validity determination unit 205.

Moreover, the priority setting unit 207 may be configured to set the priority of the traffic regulation mark in accordance with the type of the traffic regulation mark and the traveling state of the host vehicle. In other words, the priority of the traffic regulation mark may be switched in accordance with the traveling state of the host vehicle. In this case, the priority setting unit 207 may be configured to place higher priority on the traffic regulation mark that is estimated to be likely to be a target in accordance with the traveling state of the host vehicle.

Note that the correspondence relation between the type of the traffic regulation mark and the priority may be stored in advance in the nonvolatile memory of the vehicle display control device 20, and the priority setting unit 207 may set the priority of the traffic regulation mark by referring to the correspondence relation. Examples of the traveling state of the host vehicle include the speed of the host vehicle and the presence or absence of a preceding vehicle. The speed of the host vehicle may be acquired by the speed acquisition unit 201, and the presence or absence of a preceding vehicle may be determined from the traveling environment recognized by the mark recognition unit 203.

Examples in which the priority of the traffic regulation mark is set in accordance with the type of the traffic regulation mark and the traveling state of the host vehicle are as follows. Here, as the traffic regulation mark, “speed limit”, “parking prohibited”, and “passing prohibited” will be described as an example. For example, in a case where the speed of the host vehicle is lower than a set value, the priority of “parking prohibited” may be set to be higher than the priority of “speed limit”, and in a case where the speed of the host vehicle is equal to or higher than the set value, the priority of “speed limit” may be set to be higher than the priority of “parking prohibited”. Moreover, in a case where there is a preceding vehicle, the priority of “passing prohibited” may be set to be higher than the priority of “speed limit”, and in a case where there is no preceding vehicle, the priority of “speed limit” may be set to be higher than the priority of “passing prohibited”.

Note that processing of setting the priority based on the situation of the host vehicle with respect to the regulation valid range will be described in detail later.

The display control unit 208 controls the HUD 220 to display remaining amount information indicating the remaining amount for the regulation valid range identified by the remaining amount identification unit 206 in addition to regulation content information indicating the content of the regulation of the regulation valid range in accordance with the situation of the host vehicle with respect to the regulation valid range.

The regulation content information may be text information, an icon image, or a combination thereof as long as the regulation content information indicates the content of the regulation of the regulation valid range. In the present embodiment, a case where an icon image of the traffic regulation mark corresponding to the content of the regulation of the regulation valid range is used as the regulation content information will be described as an example.

The remaining amount information may be text information, an image such as a bar graph, or a combination thereof as long as the remaining amount information is information indicating the remaining amount. In the present embodiment, a case where text information indicating the remaining amount is used as the remaining amount information will be described as an example.

The display control unit 208 switches a display region in which the regulation content information and the remaining amount information are displayed between the proximal display region and the distal display region in accordance with the situation of the host vehicle with respect to the regulation valid range. In addition, the display control unit 208 may display the latest regulation content information and remaining amount information in the distal display region and then display them in the proximal display region. However, in a case where the regulation content information and the remaining amount information are displayed in the proximal display region for a plurality of types of traffic regulation marks, the display control unit 208 performs adjustment to switch a display region for the traffic regulation mark having a lower priority set by the priority setting unit 207 from the proximal display region to the distal display region.

Moreover, in a case where the regulation content information and the remaining amount information for which the display region has been switched from the proximal display region to the distal display region exist for a plurality of types of traffic regulation marks, the display control unit 208 displays information regarding the traffic regulation marks in the distal display region in order according to the priority set by the priority setting unit 207. The display control of the regulation content information and the remaining amount information performed by the display control unit 208 will be described in detail later.

In addition, the display control unit 208 may display the display for the traffic regulation mark having the lowest priority set by the priority setting unit 207 in a display mode in which the driver can recognize that the priority is set to the lowest priority. That is, the display control unit 208 may change a display mode of information regarding a traffic regulation mark that has been determined as being not valid by the mark validity determination unit 205 to be different from a display mode of information regarding a traffic regulation mark that has been determined as being valid by the mark validity determination unit 205. Specifically, the display control unit 208 may display, in the distal display region, information regarding the traffic regulation mark that has been determined as being not valid by the mark validity determination unit 205. Moreover, the display may be performed in a display mode indicating that the traffic regulation mark has been determined as being not valid by the mark validity determination unit 205, that is, in a display mode in which the driver can recognize that the traffic regulation mark has been determined as being not valid by the mark validity determination unit 205.

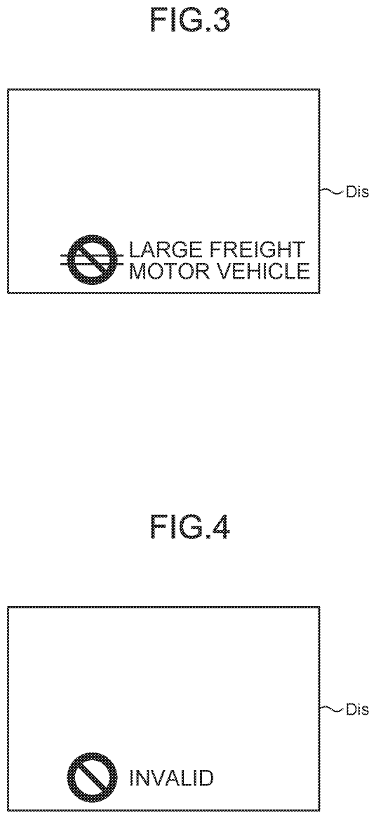

Examples of the display mode in which the driver can recognize that the traffic regulation mark has been determined as being not valid by the mark validity determination unit 205 include a display mode in which a strikethrough line is drawn on the display for traffic regulation mark. The strikethrough line is represented by, for example, a single line, a double line, or the like. Hereinafter, a description will be given assuming that the strikethrough line is a double line. For example, as illustrated in FIG. 3, the display control unit 208 draws a double line on an icon image imitating a traffic regulation mark displayed in a distal display region Dis. At this time, as illustrated in FIG. 3, the display control unit 208 may display, in the form of text or the like, supplementary content information indicating the regulation target vehicle type and the regulation application time for the traffic regulation mark near the image in which the double line is drawn. In addition, the display control unit 208 may make the display for the traffic regulation mark lighter in color than the display for another traffic regulation mark, or may display the display for the traffic regulation mark with high transparency. In addition, the display control unit 208 may make the display for the traffic regulation mark smaller than the display for another traffic regulation mark, or may display the display for the traffic regulation mark with a broken line.

In addition, the display control unit 208 may display another mark that enables the driver to recognize that the traffic regulation mark has been determined as being not valid by the mark validity determination unit 205, near the display for the traffic regulation mark. For example, as illustrated in FIG. 4, the display control unit 208 may display characters such as “invalid” near the icon image imitating the traffic regulation mark displayed in the distal display region Dis as another mark that enables the driver to recognize that the traffic regulation mark has been determined as being not valid by the mark validity determination unit 205. In addition, the display control unit 208 may delete the display for the traffic regulation mark determined that has been determined as being not valid by the mark validity determination unit 205. At this time, the display control unit 208 may delete the display for the traffic regulation mark by so-called fading-out in which the transparency of the display for the traffic regulation mark is gradually increased or the brightness of the display is gradually lowered, or may delete the display after blinking the display for the traffic regulation mark.

Note that the display control unit 208 may apply one of the above-described examples of the display mode in which the driver can recognize that the traffic regulation mark has been determined as being not valid by the mark validity determination unit 205 to the display for the traffic regulation mark, or may apply a combination of the plurality of examples. As an example of applying a combination of the plurality of examples, a double line is drawn on an icon image imitating the traffic regulation mark, and the display for the traffic regulation mark is displayed with a lighter color than the display for another traffic regulation mark.

Although FIGS. 3 and 4 illustrate an example in which the remaining amount information is not displayed, the remaining amount information may be displayed. In this case, a display mode of the remaining amount information may be changed similarly to the display control for the regulation content information described above.

In addition, the display control unit 208 may be configured to switch whether to display information indicating the remaining traveling distance or information indicating the remaining traveling time as the remaining amount information in accordance with selection received from the driver via the operation device 21. Note that information indicating both the remaining traveling distance and the remaining traveling time may be displayed. In addition, the display control unit 208 may be configured to be capable of switching whether or not the display is performed on the HUD 220 or selectively canceling the display of the regulation content information and the remaining amount information for a specific traffic regulation mark in accordance with selection received from the driver via the operation device 21.

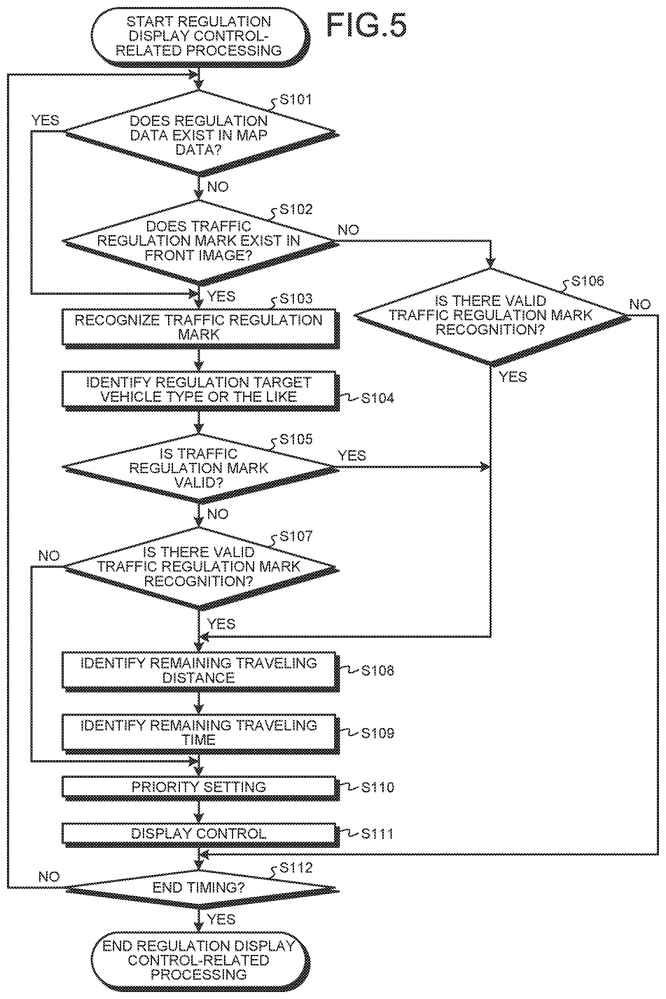

Regulation Display Control-Related Processing in Vehicle Display Control Device Next, an example of a flow of processing related to the control of the display of the traffic regulation mark performed by the HUD 220 in the vehicle display control device 20 (hereinafter, referred to as regulation display control-related processing) will be described with reference to FIG. 5.

FIG. 5 is a flowchart illustrating an example of the regulation display control-related processing of the vehicle display control device 20. In the flowchart of FIG. 5, the processing may be started when a power supply of the HUD 220 is turned on and the function of the HUD 220 is turned on. The function of the HUD 220 may be switched on or off in accordance with an input operation received by the operation device 21. The power supply of the HUD 220 may be configured to be turned on or off in accordance with on or off of a switch for starting an internal combustion engine or a motor generator of the host vehicle (hereinafter, referred to as a power switch).

First, in Step S101, the mark recognition unit 203 determines whether or not regulation data associated with a link present in front of the host vehicle in the traveling direction exists in the map data. In a case where the mark recognition unit 203 determines that the regulation data exists (YES in Step S101), the processing proceeds to Step S103. On the other hand, in a case where the mark recognition unit 203 determines that the regulation data does not exist (NO in Step S101), the processing proceeds to Step S102.

In Step S102, the mark recognition unit 203 determines whether or not the traffic regulation mark can be recognized from the front image. In a case where the mark recognition unit 203 determines that the traffic regulation mark can be recognized (YES in Step S102), the processing proceeds to Step S103.

In Step S103, the mark recognition unit 203 recognizes the traffic regulation mark present in front of the host vehicle in the traveling direction. Thereafter, the processing proceeds to Step S104.

In Step S104, the mark identification unit 204 identifies the regulation target vehicle type, the regulation application time, and the regulation valid range for the traffic regulation mark recognized in Step S103. Thereafter, the processing proceeds to Step S105.

In Step S105, the mark validity determination unit 205 determines whether or not the traffic regulation mark is valid on the basis of the regulation target vehicle type and the regulation application time for the traffic regulation mark identified in Step S104. In a case where the mark validity determination unit 205 determines that the traffic regulation mark is valid (YES in Step S105), the processing proceeds to Step S108.

On the other hand, in a case where the mark recognition unit 203 determines that the traffic regulation mark cannot be recognized (NO in Step S102), the processing proceeds to Step S106. In Step S106, the remaining amount identification unit 206 determines whether or not there is a traffic regulation mark that has already been determined as being valid. That is, the remaining amount identification unit 206 determines whether or not there is a traffic regulation mark that has been determined as being valid and has a regulation valid range in which the host vehicle is currently positioned. In a case where the remaining amount identification unit 206 determines that there is a traffic regulation mark that has already been determined as being valid (YES in Step S106), the processing proceeds to Step S108.

Further, in a case where the mark validity determination unit 205 determines that the traffic regulation mark is not valid (NO in Step S105), the processing proceeds to Step S107. Also in Step S107, similarly to Step S106, the remaining amount identification unit 206 determines whether or not there is a traffic regulation mark that has already been determined as being valid. In a case where the remaining amount identification unit 206 determines that there is a traffic regulation mark that has already been determined as being valid (YES in Step S107), the processing proceeds to Step S108.

In Step S108, the remaining amount identification unit 206 identifies the remaining traveling distance as the start remaining amount or the end remaining amount. Before the host vehicle enters the target regulation valid range, the remaining amount identification unit 206 identifies the remaining traveling distance as the start remaining amount for the regulation valid range. On the other hand, after the host vehicle enters the regulation valid range, the remaining amount identification unit 206 identifies the remaining traveling distance as the end remaining amount for the regulation valid range. Thereafter, the processing proceeds to Step S109.

In Step S109, the remaining amount identification unit 206 identifies the remaining traveling time as the start remaining amount or the end remaining amount. Before the host vehicle enters the target regulation valid range, the remaining amount identification unit 206 identifies the remaining traveling time as the start remaining amount for the regulation valid range. On the other hand, after the host vehicle enters the regulation valid range, the remaining amount identification unit 206 identifies the remaining traveling time as the end remaining amount for the regulation valid range. Thereafter, the processing proceeds to Step S110.

On the other hand, in a case where the remaining amount identification unit 206 determines that there is no traffic regulation mark that has already been determined as being valid in Step S107 (NO in Step S107), the processing proceeds to Step S110.

In Step S110, the priority setting unit 207 sets the priority of the valid traffic regulation mark. In a case where there are a plurality of types of traffic regulation marks corresponding to the regulation valid range in which the host vehicle is positioned, the priority setting unit 207 sets respective priority of those traffic regulation marks. In addition, in a case where there is a traffic regulation mark that has been determined as being not valid by the mark validity determination unit 205, the priority setting unit 207 places the lowest priority on this traffic regulation mark. Thereafter, the processing proceeds to Step S111.

In Step S111, the display control unit 208 performs a display control to display the regulation content information and the remaining amount information for the traffic regulation mark on the HUD 220. The display control unit 208 performs the display while switching a display region in which the regulation content information and the remaining amount information are displayed between the proximal display region and the distal display region in accordance with the situation of the host vehicle with respect to the regulation valid range. In addition, in a case where there are a plurality of types of traffic regulation marks or there is a traffic regulation mark that has been determined as being not valid by the mark validity determination unit 205, the display control unit 208 adjusts the display of the regulation content information and the remaining amount information in accordance with the priority set by the priority setting unit 207 in Step S10. Thereafter, the processing proceeds to Step S112.

On the other hand, in a case where the remaining amount identification unit 206 determines that there is no traffic regulation mark that has already been determined as being valid in Step S106 (NO in Step S106), the processing proceeds to Step S112.

In Step S112, in a case where it is an end timing of the regulation display control-related processing (YES in Step S112), the regulation display control-related processing ends. Examples of the end timing of the regulation display control-related processing include a case where the power switch of the host vehicle is turned off and a case where the function of the HUD 220 is turned off.

On the other hand, in a case where it is not the end timing of the regulation display control-related processing (NO in Step S112), the processing returns to Step S101, and the processing of Step S101 and the subsequent processing is performed.

Example of Display Control for One Type of Valid Traffic Regulation Mark

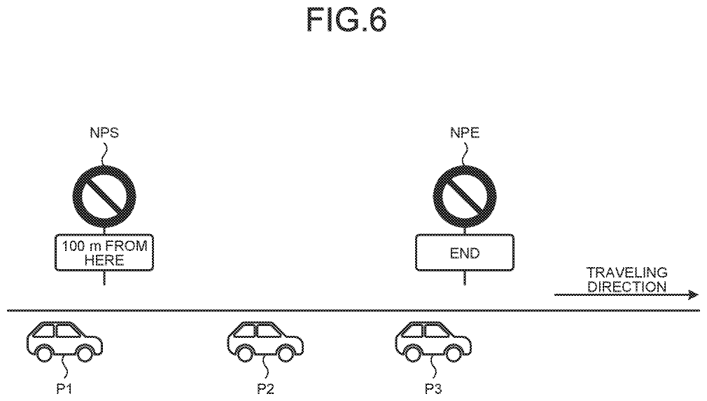

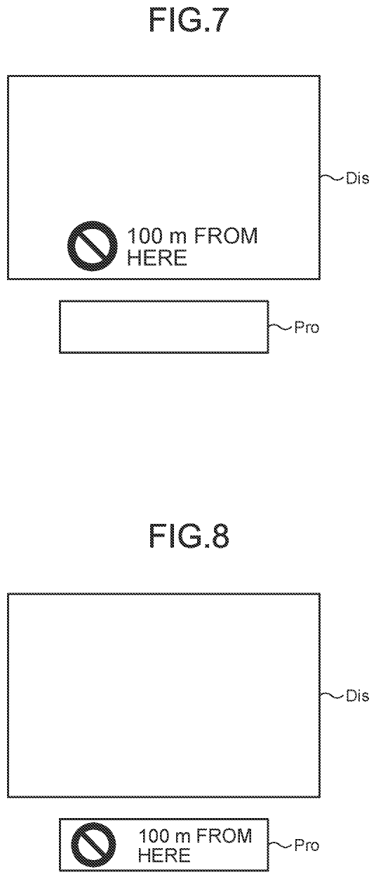

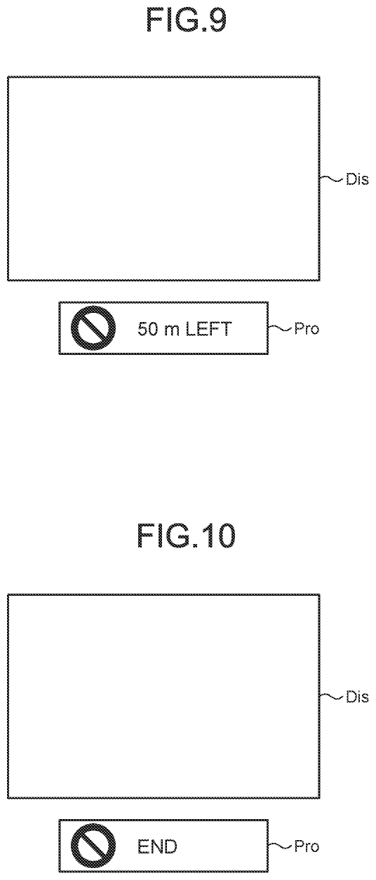

An example of the display control performed by the display control unit 208 in a case where there is one type of valid traffic regulation mark will be described with reference to FIGS. 6 to 10. FIG. 6 is a schematic diagram illustrating an example of a situation of the host vehicle with respect to the regulation valid range. FIGS. 7 to 10 are diagrams illustrating examples of the display of the regulation content information and the remaining amount information in a proximal display region Pro and the distal display region Dis in accordance with the traveling situation of the host vehicle in FIG. 6. FIGS. 7 and 8 are diagrams illustrating an example of the display at a vehicle position P1. FIG. 9 is a diagram illustrating an example of the display at a vehicle position P2, and FIG. 10 is a diagram illustrating an example of the display at a vehicle position P3. In FIGS. 6 to 10, a case where the traffic regulation mark is “parking prohibited” and the regulation valid range is 100 m will be described as an example.

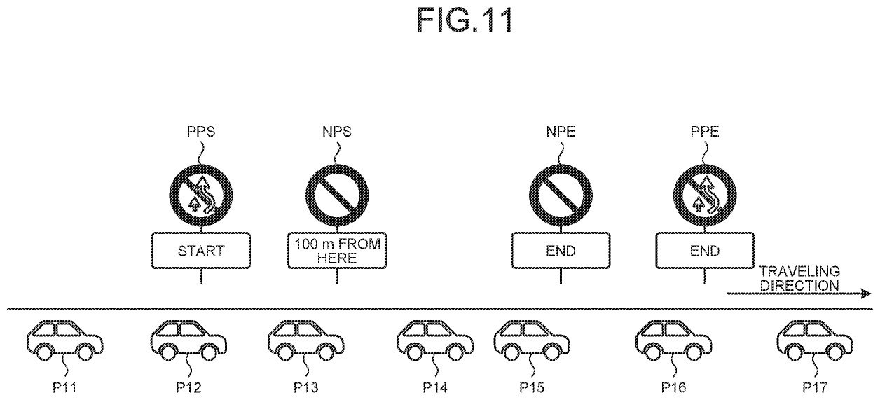

FIG. 6 illustrates a sign NPS including the regulation sign of “parking prohibited” and the supplementary sign provided at the start position of the regulation valid range. In addition, FIG. 6 illustrates a sign NPE including the regulation sign of “parking prohibited” and the supplementary sign provided at the end position of the regulation valid range. FIG. 6 illustrates the vehicle positions P1 to P3 of the host vehicle. The vehicle position P1 indicates a vehicle position at which the sign NPS and a front portion of the host vehicle are positioned at the same position, that is, a vehicle position when the host vehicle enters the regulation valid range (hereinafter, referred to as a regulation valid range of “parking prohibited”) corresponding to the regulation sign of “parking prohibited”. The vehicle position P2 indicates a vehicle position when the host vehicle is positioned between the sign NPS and the sign NPE, that is, a vehicle position when the host vehicle is positioned within the regulation valid range of “parking prohibited”. The vehicle position P3 indicates a vehicle position when the host vehicle passes through the sign NPE, that is, a vehicle position at the time of exiting the regulation valid range of “parking prohibited”. Note that the similar manner is also applied to FIGS. 11 to 21 described below.

When the host vehicle enters the regulation valid range of “parking prohibited” (the vehicle position P1 in FIG. 6), the display control unit 208 displays, in the distal display region Dis as illustrated in FIG. 7, an icon image imitating the sign of “parking prohibited” as the regulation content information and a text such as “100 m from here” as the remaining amount information indicating the end remaining amount. As a result, it is possible to cause the driver to recognize the newly identified traffic regulation mark. The regulation content information and the remaining amount information at this time are displayed on the lower side of the distal display region Dis so as not to disturb the field of view of the driver. Note that the display in the distal display region Dis is temporary, and the display control unit 208 then switches the display region of the regulation content information and the remaining amount information to the proximal display region Pro as illustrated in FIG. 8.

After the host vehicle enters the regulation valid range of “parking prohibited” until the time of exiting (the vehicle position P2 in FIG. 6), an icon image imitating the sign of “parking prohibited” and a text such as “50 m left” indicating the end remaining amount are displayed in the proximal display region Pro as illustrated in FIG. 9. The text indicating the end remaining amount may be updated and displayed in accordance with the end remaining amount sequentially identified by the remaining amount identification unit 206. The similar manner is applied to an example of a display control in a case where there are two types of valid traffic regulation marks and an example of a display control in a case where there are three or more types of valid traffic regulation marks described below.

Then, at a point in time when the host vehicle exits the regulation valid range of “parking prohibited” (the vehicle position P3 in FIG. 6), the display control unit 208 displays an icon image imitating the sign of “parking prohibited” and a text such as “end” as the end remaining amount in the proximal display region Pro as illustrated in FIG. 10. That is, the fact that the traffic regulation mark “parking prohibited” becomes invalid is indicated. The text displayed as the end remaining amount may be configured to display the content recognized from the supplementary sign provided at the end point of the regulation valid range. Moreover, the text displayed as the end remaining amount may be “0 m left” or the like. The similar manner is applied to an example of a display control in a case where there are two types of valid traffic regulation marks and an example of a display control in a case where there are three or more types of valid traffic regulation marks described below.

When the host vehicle has exited the regulation valid range of “parking prohibited”, the display control unit 208 deletes the regulation content information and the remaining amount information displayed in the proximal display region Pro until then. That is, the display of the regulation content information and the remaining amount information corresponding to the regulation valid range from which the host vehicle has exited is terminated. Note that the display control unit 208 may be configured to display, in the distal display region Dis together with the regulation content information, the remaining amount information indicating the start remaining amount for the regulation valid range before the host vehicle enters the regulation valid range for the purpose of giving notice of entry into the regulation valid range to the driver.

Example of Display Control for Two Types of Valid Traffic Regulation Marks

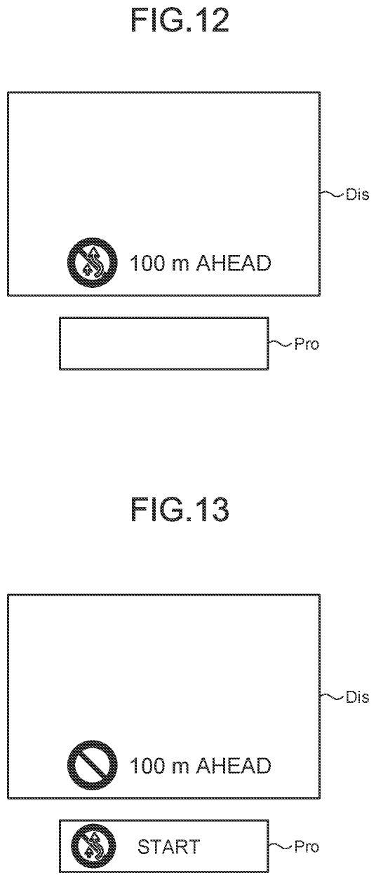

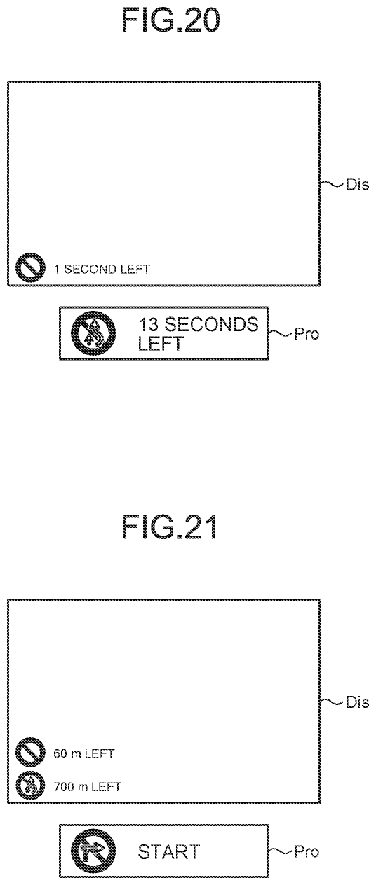

An example of the display control performed by the display control unit 208 in a case where there are two types of valid traffic regulation marks will be described with reference to FIGS. 11 to 20. In FIGS. 11 to 20, a case where the traffic regulation marks are “passing prohibited” and “parking prohibited”, the regulation valid range of “passing prohibited” is 800 m, and the regulation valid range of “parking prohibited” is 100 m will be described as an example. In addition, in FIGS. 11 to 20, a case where the regulation valid range of “parking prohibited” overlaps with part of the regulation valid range of “passing prohibited” will be described as an example. FIG. 11 is a schematic diagram illustrating an example of a situation of the host vehicle with respect to the regulation valid range. FIGS. 12 to 20 are diagrams illustrating examples of the display of the regulation content information and the remaining amount information in the proximal display region Pro and the distal display region Dis in accordance with the traveling situation of the host vehicle in FIG. 11. Specifically, FIGS. 12 to 18 are diagrams illustrating examples of the display at vehicle positions P11 to P17, respectively, and FIGS. 19 and 20 are diagrams illustrating another example of the display at the vehicle position P14.

In the example illustrated in FIG. 11, the sign NPS is a sign including the regulation sign of “parking prohibited” and the supplementary sign provided at the start position of the regulation valid range of “parking prohibited”. In addition, the sign NPE is a sign including the regulation sign of “parking prohibited” and the supplementary sign provided at the end position of the regulation valid range. Moreover, in the example illustrated in FIG. 11, a sign PPS is a sign including the regulation sign of “passing prohibited” and the supplementary sign provided at the start position of the regulation valid range of “passing prohibited”. In addition, the sign PPE is a sign including the regulation sign of “passing prohibited” and the supplementary sign provided at the end position of the regulation valid range.

FIG. 11 illustrates the vehicle positions P11 to P17 of the host vehicle. The vehicle position P11 indicates a vehicle position before the host vehicle enters the regulation valid range of “passing prohibited”. The vehicle position P12 indicates a vehicle position at which the sign PPS and the front portion of the host vehicle are positioned at the same position, that is, a vehicle position when the host vehicle enters the regulation valid range (hereinafter, referred to as the regulation valid range of “passing prohibited”) corresponding to the regulation sign of “passing prohibited”. The vehicle position P13 indicates a vehicle position at which the sign NPS and the front portion of the host vehicle are positioned at the same position, that is, a vehicle position when the host vehicle enters the regulation valid range of “parking prohibited”. The vehicle position P14 indicates a vehicle position when the host vehicle is positioned within both the regulation valid range of “passing prohibited” and the regulation valid range of “parking prohibited”. The vehicle position P15 indicates a vehicle position when the host vehicle passes through the sign NPE, that is, a vehicle position at the time of exiting the regulation valid range of “parking prohibited”. The vehicle position P16 indicates a vehicle position when the host vehicle passes through the sign PPE, that is, a vehicle position at the time of exiting the regulation valid range of “passing prohibited”. The vehicle position P17 indicates a vehicle position after exiting the regulation valid range of “passing prohibited”.

Before the host vehicle enters the regulation valid range of “passing prohibited” (the vehicle position P11 in FIG. 11), the display control unit 208 displays, in the distal display region Dis as illustrated in FIG. 12, an icon image imitating the sign of “passing prohibited” as the regulation content information and a text such as “100 m ahead” as the remaining amount information indicating the start remaining amount.

When the host vehicle enters the regulation valid range of “passing prohibited” (the vehicle position P12 in FIG. 7), the display control unit 208 displays, in the proximal display region Pro as illustrated in FIG. 13, an icon image imitating the sign of “passing prohibited” as the regulation content information and a text such as “start” indicating that the regulation valid range starts. The display control unit 208 displays, in the distal display region Dis, an icon image imitating the sign of “parking prohibited” as the regulation content information and a text such as “100 m ahead” as the remaining amount information indicating the start remaining amount.

Note that the display control unit 208 may be configured to display a text such as “800 m from here” as the remaining amount information indicating the end remaining amount, instead of displaying a text indicating that the regulation valid range starts in the proximal display region Pro. Alternatively, the display control unit 208 may be configured to temporarily display a text “start” and then display a text such as “800 m from here”.

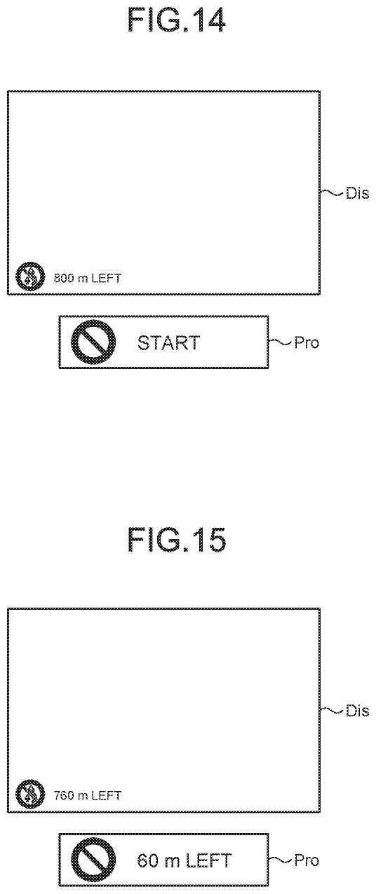

Subsequently, when the host vehicle enters the regulation valid range of “parking prohibited” (the vehicle position P13 in FIG. 11), the display control unit 208 displays, in the proximal display region Pro as illustrated in FIG. 14, an icon image imitating the sign of “parking prohibited” as the regulation content information corresponding to a newly valid traffic regulation mark, and a text such as “start” indicating that the regulation valid range starts. The display control unit 208 displays, in the distal display region Dis, an icon image imitating the sign of “passing prohibited” as the regulation content information corresponding to the traffic regulation mark that has already been valid, and a text such as “800 m left” as the remaining amount information indicating the end remaining amount. Note that the display control unit 208 may be configured to display information corresponding to the traffic regulation mark that has already been valid in the proximal display region Pro and then display the information in the distal display region Dis, as information corresponding to the newly valid traffic regulation mark is displayed in the proximal display region Pro.

In a case where the host vehicle is positioned in a region where the regulation valid range of “passing prohibited” and the regulation valid range of “parking prohibited” overlap with each other (the vehicle position P14 in FIG. 11), the display control unit 208 displays, in the proximal display region Pro as illustrated in FIG. 15, an icon image imitating the sign of “parking prohibited” corresponding to the regulation valid range of “parking prohibited” whose end remaining amount is smaller, and a text such as “remaining 60 m” indicating the end remaining amount. On the other hand, the display control unit 208 displays, in the distal display region Dis, an icon image imitating the sign of “passing prohibited” corresponding to the regulation valid range of “passing prohibited” whose end remaining amount is larger, and a text such as “remaining 760 m” indicating the end remaining amount. In this case, since the regulation content information and the remaining amount information for the regulation valid range whose end remaining amount is smaller are preferentially displayed in the proximal display region Pro, the driver can more easily recognize the situation of the host vehicle with respect to each regulation valid range indicated by the plurality of types of traffic regulation marks.

The display control unit 208 may be configured to display information regarding a traffic regulation mark having a higher priority set by the priority setting unit 207 in the proximal display region Pro, and display information regarding a traffic regulation mark having a lower priority in the distal display region Dis. In a case where the display region in which the regulation content information and the remaining amount information for the traffic regulation mark having a lower priority are displayed has been switched from the proximal display region Pro to the distal display region Dis, the display control unit 208 displays the regulation content information and the remaining amount information displayed in the distal display region Dis in a more inconspicuous mode than that when the regulation content information and the remaining amount information are initially displayed in the distal display region Dis.

The term “initially” expressed herein refers to a point in time when the host vehicle enters the regulation valid range for the traffic regulation mark. Examples of the inconspicuous mode include a display mode in which a display size is reduced, a display mode in which a display luminance is reduced, and a display mode in which a display position is set to a position more deviated from the center of the distal display region Dis. As a result, it is possible to make it easier for the driver to distinguish information displayed in the distal display region Dis at the time of entering the regulation valid range while preventing the field of view of the driver from being obstructed.

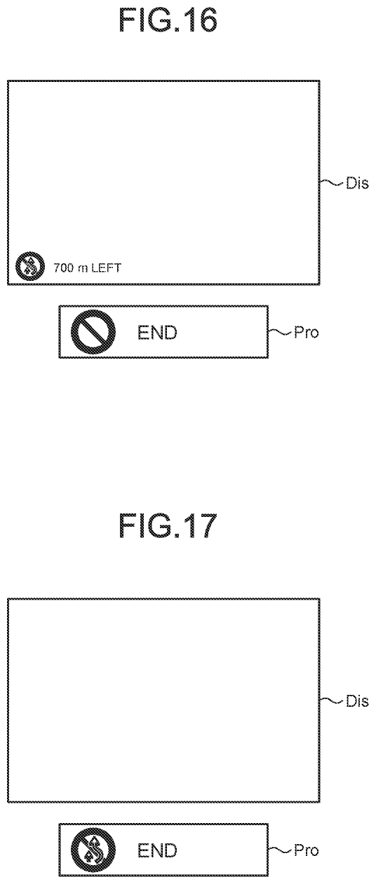

Then, at a point in time when the host vehicle exits the regulation valid range of “parking prohibited” (the vehicle position P15 in FIG. 11), the display control unit 208 displays an icon image imitating the sign of “parking prohibited” and a text such as “end” as the end remaining amount in the proximal display region Pro as illustrated in FIG. 16. That is, the fact that the traffic regulation mark “parking prohibited” becomes invalid is indicated. The display control unit 208 continuously displays, in the distal display region Dis, the regulation content information and the remaining amount information corresponding to the regulation valid range of “passing prohibited”. As a specific example, the display control unit 208 displays an icon image imitating the sign of “passing prohibited” and a text such as “700 m left” indicating the end remaining amount.

At a point in time when the host vehicle exits the regulation valid range of “passing prohibited” (the vehicle position P16 in FIG. 11), the display control unit 208 displays an icon image imitating the sign of “passing prohibited” and a text such as “end” as the end remaining amount in the proximal display region Pro as illustrated in FIG. 17. That is, the fact that the traffic regulation mark “passing prohibited” becomes invalid is indicated. The display control unit 208 ends the display of the regulation content information and the remaining amount information corresponding to the regulation valid range of “passing prohibited” in the distal display region Dis.

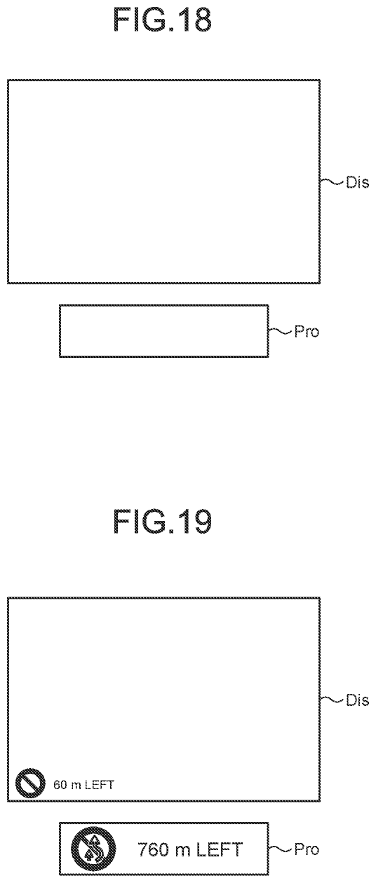

In a case where the host vehicle has exited the regulation valid range of “passing prohibited” (the vehicle position P17 in FIG. 11), the display control unit 208 deletes the regulation content information and the remaining amount information displayed in the proximal display region Pro as illustrated in FIG. 18. In addition, since there is no valid traffic regulation mark, the display control unit 208 does not display the regulation content information and the remaining amount information also in the distal display region Dis as illustrated in FIG. 18.

Note that, in FIG. 15, an example of a case where the traffic regulation mark whose end remaining amount is smaller has a higher priority is illustrated, but the present disclosure is not necessarily limited thereto. In accordance with the setting of the priority in the priority setting unit 207, the regulation content information and the remaining amount information corresponding to the regulation valid range of “passing prohibited” may be displayed in the proximal display region Pro, and the regulation content information and the remaining amount information corresponding to the regulation valid range of “parking prohibited” may be displayed in the distal display region Dis as illustrated in FIG. 19.

In addition, in FIGS. 7 to 10 and FIGS. 12 to 19, the remaining traveling distance is displayed as the start remaining amount and the end remaining amount, but the present disclosure is not necessarily limited thereto. For example, as illustrated in FIG. 20, the remaining traveling time may be displayed as the remaining amount.

Example of Display Control for Three or More Types of Valid Traffic Regulation Marks

An example of the display control performed by the display control unit 208 in a case where there are three or more types of valid traffic regulation marks will be described with reference to FIG. 21. FIG. 21 is a view illustrating another example of the display of the regulation content information and the remaining amount information in the proximal display region Pro and the distal display region Dis in accordance with the traveling situation of the host vehicle. In FIG. 21, a case where there are three types of traffic regulation marks, “passing prohibited”. “parking prohibited”, and “vehicle crossing prohibited”, will be described as an example. Note that a case other than a case where the regulation valid ranges of the three types of traffic regulation marks overlap with each other is similar to a case where there are two or more types of valid traffic regulation marks described above, and thus a description thereof will be omitted.

In a case where the host vehicle is positioned in a region where the regulation valid range of “passing prohibited”, the regulation valid range of “parking prohibited”, and the regulation valid range of “vehicle crossing prohibited” overlap with one another, the display control unit 208 displays, in the proximal display region Pro, the regulation content information and the remaining amount information for the traffic regulation mark having the highest priority set by the priority setting unit 207. On the other hand, the display control unit 208 may be configured to arrange and display the regulation content information and the remaining amount information for the remaining traffic regulation marks in order from the one with the highest priority set by the priority setting unit 207 at a position closer to the proximal display region Pro in the distal display region Dis.

With such a configuration, as the traffic regulation marks are arranged in the order of the set priority, the driver can more easily recognize the situation of the host vehicle with respect to the respective regulation valid ranges indicated by the three or more types of traffic regulation marks. For example, in a case where the priority of the traffic regulation mark with respect to the regulation valid range whose end remaining amount is smaller is set to be higher, information regarding the regulation valid range whose end remaining amount is smaller is displayed at a position closer to the proximal display region Pro, so that the driver can intuitively recognize a larger or smaller remaining amount with respect to each regulation valid range.

In addition, the display control unit 208 may display the regulation content information and the remaining amount information for the traffic regulation mark having a higher priority set by the priority setting unit 207 in a larger size or in a higher luminance to achieve a similar effect.

Note that, in the above-described example, the description has been given by exemplifying “passing prohibited”, “parking prohibited”, and “vehicle crossing prohibited” as the traffic regulation marks, but the traffic regulation marks are not necessarily limited thereto. Other traffic regulation marks such as “speed limit” may be applied as long as a regionally valid range is defined for the regulation indicated by the traffic regulation mark.

### Summary of Embodiment

As described above, the vehicle display control device 20 according to the present embodiment includes the mark recognition unit 203, the mark validity determination unit 205, and the display control unit 208. In a case where the mark validity determination unit 205 determines that the regulation content information is not valid, the display control unit 208 changes the display mode of the regulation content information. Specifically, the display control unit 208 causes the regulation content information to be displayed in a display mode in which the driver can recognize that the mark validity determination unit 205 has determined that the regulation content information is not valid.

With the configuration above, in a case where the regulation content information is not valid, the display mode of the regulation content information can be changed to a display mode different from that in a case where the regulation content information is valid. Therefore, the present embodiment enables the driver to more easily recognize that the regulation content information is not valid, and the regulation content information and the like can be displayed more appropriately for the driver.

In addition, the vehicle display control device 20 according to the present embodiment further includes the priority setting unit 207. In a case where the mark validity determination unit 205 determines that the regulation content information is not valid, the priority setting unit 207 places the lowest priority on the regulation content information. The display control unit 208 changes the display mode of the regulation content information on the basis of the setting of the priority performed by the priority setting unit 207.

As a result, the display control is performed on the basis of the priority set by the priority setting unit 207, and the display mode of the regulation content information that is not valid is changed on the basis of the set lowest priority. Therefore, the present embodiment enables the driver to more easily recognize that the regulation content information is not valid, and the regulation content information and the like can be displayed more appropriately for the driver.

Moreover, according to the present embodiment, the display region in which the regulation content information and the remaining amount information are displayed is switched in accordance with the situation (that is, a positional relationship) of the host vehicle with respect to the regulation valid range. As a result, the driver can more easily recognize the situation of the host vehicle with respect to the regulation valid range by the change of the display region in which the regulation content information and the remaining amount information are displayed. As a specific example, at the time of entering the regulation valid range, the regulation content information and the remaining amount information are first displayed in the distal display region Dis, and then are displayed in the proximal display region Pro. Therefore, the driver can more easily recognize that the vehicle has newly entered the regulation valid range.

Moreover, according to the present embodiment, in a case where the host vehicle is positioned in a region where the regulation valid ranges indicated by a plurality of types of traffic regulation marks overlap with each other, the display region in which the regulation content information and the remaining amount information for each regulation valid range are displayed is switched in accordance with the situation of the host vehicle. As a result, the driver can more easily recognize the situation of the host vehicle with respect to each regulation valid range. For example, at the time of entering the regulation valid range, the regulation content information and the remaining amount information are first displayed in the distal display region Dis, and the driver can thus more easily recognize which regulation valid range the vehicle has newly entered. In addition, the regulation content information and the remaining amount information for each regulation valid range are in the display region, and the driver can thus more easily recognize the situation of the host vehicle with respect to each regulation valid range.

### Other Embodiments

In the above-described embodiment, the regulation target vehicle type and the regulation application time are identified mainly on the basis of the supplementary data or the content of the supplementary sign. Alternatively, the regulation target vehicle type and the regulation application time may be identified on the basis of the regulation data or the content of the main sign. For example, in a case where the mark recognition unit 203 recognizes a road closure sign on which a large freight motor vehicle or the like is drawn, the mark identification unit 204 identifies that the regulation target vehicle type is a large freight motor vehicle or the like.

Moreover, in the above embodiment, a determination of whether or not the traffic regulation mark is valid is performed on the basis of the regulation target vehicle type and the regulation application time has been described. Alternatively, the determination may be determined on the basis of a regulation traveling environment such as weather information. Examples of the traffic regulation mark for which such a determination is made include a sign “Lights On When Using Wipers” and a sign “Lights On When Raining” in the United States.

In this case, the mark recognition unit 203 may further identify a regulation traveling environment, which is a traveling environment as a regulation target indicated by the traffic regulation mark. In addition, the mark identification unit 204 may be configured to further identify the regulation traveling environment, which is a traveling environment as the regulation target, from the regulation data or the supplementary data including the above-described vehicle traveling condition data among the map data stored in the map database 4. The regulation traveling environment is represented by, for example, weather information or the like. In addition, the mark identification unit 204 may be configured to further identify the regulation traveling environment from the content of the traffic regulation mark in a case where the content of the traffic regulation mark has been recognized by the mark recognition unit 203 from the front image acquired from the front camera. For example, in a case where the content of a road sign such as “lights on when raining” has been recognized, the mark identification unit 204 may identify rainy weather as the regulation traveling environment. For example, in a case where the content of a road sign such as “lights on when using wipers” has been recognized, the mark identification unit 204 may identify bad weather as the regulation traveling environment.

Then, the mark validity determination unit 205 may further determine whether or not the traffic regulation mark is valid on the basis of the regulation traveling environment indicated by the traffic regulation mark identified by the mark identification unit 204. Specifically, the mark validity determination unit 205 may acquire the weather information, determine that these traffic regulation marks are valid in bad weather or rainy weather, and determine that these traffic regulation marks are not valid otherwise. Note that the mark validity determination unit 205 may acquire the weather information on the basis of the fact that the vehicle state sensor has detected that the wiper is continuously or intermittently operated for a certain period of time or more, may acquire the weather information on the basis of the fact that the surrounding monitoring sensor 6 has detected that it is raining, or may acquire the weather information distributed by the meteorological agency or the like from the server 8.

In addition, the mark validity determination unit 205 may determine whether or not the traffic regulation mark is valid on the basis of the detection result of the vehicle state sensor 5. For example, it is assumed that there is an intersection where the host vehicle can turn left in front of the road on which the host vehicle is traveling, and there is a traffic regulation mark that is valid when the host vehicle turns left. In such a case, the mark validity determination unit 205 determines that the traffic regulation mark is valid in a case where it is detected by the vehicle state sensor 5 that a blinker for left turn has been operated, and determines that the traffic regulation mark is not valid in a case where it is not detected that the blinker for left turn has been operated.

In addition, the priority may be weighted in accordance with the type of the traffic regulation mark. For example, in a case where the host vehicle is positioned in a region where the regulation valid ranges indicated by a plurality of types of traffic regulation marks overlap with each other, the display control unit 208 may display the regulation content information and the like of the traffic regulation mark for which a higher weight is set in the proximal display region and display the regulation content information and the like of other traffic regulation marks in the distal display region.

In this case, the weighting and display control related to the setting of the priority may be set on the basis of information transmitted from the server 8 to the host vehicle. For example, the information transmitted from the server 8 is a driver model generated on the basis of a traveling history of the driver of the host vehicle, and the vehicle display control device 20 may perform the weighting related to the setting of the priority on the basis of the driver model. In this case, the vehicle display control device 20 can perform the display control more suitable for the driver of the host vehicle on the basis of a driving tendency of the driver of the host vehicle.

Specifically, in a case where the driver of the host vehicle has a strong tendency to exceed the speed limit, the vehicle display control device 20 sets a high weight for the setting of the priority for the speed limit sign on the road on the basis of the driver model indicating this tendency. As a result, the display control based on the high priority is performed for the display of the regulation content information and the like, and the excess of the speed limit by the driver can be suppressed, that is, the display control suitable for the driver can be performed. Note that the driver model referred to herein is not limited to a model for an individual driver or a single host vehicle, and may be a model obtained by modeling behavior patterns or the like of a group of people or a large number of vehicles.

As another example, the information transmitted from the server 8 is data of a traffic violation or a traffic accident in the past on the route on which the host vehicle is traveling, and the vehicle display control device 20 may perform weighting related to the setting of the priority on the basis of the data. As a result, for example, a high weight can be set for the setting of the priority for the traffic regulation mark strongly related to the cause of the traffic violation or the traffic accident, and the traffic violation and the traffic accident can be suppressed.

As still another example, the information transmitted from the server 8 is information regarding a display control in another vehicle traveling on the route on which the host vehicle is traveling, and the vehicle display control device 20 may perform the control of the display of the regulation content information and the like on the basis of the information regarding the display control. As a result, it is possible to perform the display control such as deleting unnecessary regulation content information or the like without an input or the like from the driver of the host vehicle via the operation device 21.

Moreover, in the above embodiment, a plurality of display regions, in which the regulation content information and the remaining amount information are displayed, are treated as display regions of virtual images respectively corresponding to a plurality of projection regions of the HUD 220 has been described. However, the present disclosure is not necessarily limited thereto. For example, the plurality of display regions in which the regulation content information and the remaining amount information are displayed may be the display region of the HUD 220 and the display region of the display device 22 of a type other than the HUD 220. The display device 22 used as the display device 22 of a type other than the HUD 220 is preferably the combination meter, the CID, or the like described above so that the movement of the line of sight of the driver can be suppressed.

For example, the display region of the HUD 220 may be used as the distal display region Dis in accordance with the above embodiment, and the display region of the combination meter or the CID may be used as the proximal display region Pro. Note that the display region of the combination meter or the CID may be used as the distal display region Dis, and a display region that is not used as the distal display region Dis among the display regions of the combination meter and the CID may be used as the proximal display region Pro. In this case, it is preferable that the display region of the CID and the display region of the combination meter are arranged in the top-bottom direction from the viewpoint of suppressing the movement of the line of sight of the driver.

In addition, in the above embodiment, there are two display regions in which the regulation content information and the remaining amount information can be displayed, whereas the present disclosure is not necessarily limited thereto. For example, the number of display regions in which the regulation content information and the remaining amount information can be displayed may be three or more. Also in this case, after the regulation content information and the remaining amount information are displayed in a display region in which an image seen more distally from the driver seated on the driver's seat among a plurality of display regions, the display region in which the regulation content information and the remaining amount information are displayed may be switched to a display region in which an image seen more proximally from the driver seated on the driver's seat.

In addition, the display control unit 208 may change the display positions of the regulation content information and the remaining amount information on the windshield 10 in accordance with the actual position of the traffic regulation mark. For example, in a case where there is a traffic regulation mark on the left side of the road on which the host vehicle travels and the mark recognition unit 203 recognizes the traffic regulation mark, the display control unit 208 may control the HUD 220 to display an image indicating the content of the regulation on the left side of the proximal display region or the distal display region.

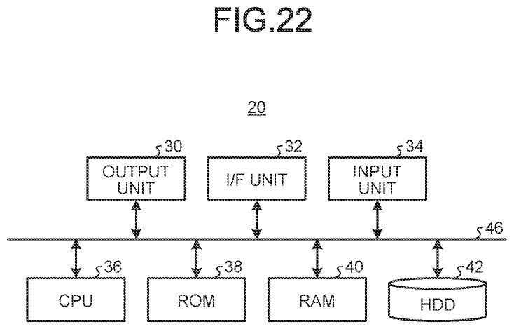

FIG. 22 is a hardware configuration diagram of an example of the vehicle display control device 20 according to the present embodiment.

The vehicle display control device 20 according to the above embodiment includes a control device such as a central processing unit (CPU) 36, a storage or memory device such as a read-only memory (ROM) 38, a random-access memory (RAM) 40, or a hard disk drive (HDD) 42, an interface (I/F) unit 32 which is an interface with various devices, an output unit 30 that outputs various types of information such as output information, an input unit 34 that receives an operation from a user, and a bus 46 that connects the respective units, and has a hardware configuration using a normal computer.

A program for performing each processing described above, executed by the vehicle display control device 20 according to the above embodiment is a file in an installable format or an executable format, and may be provided by being recorded on a computer-readable recording medium such as a CD-ROM, a flexible disk (FD), a CD-R, or a digital versatile disk (DVD).

In addition, the program for performing each processing executed by the vehicle display control device 20 according to the above embodiment may be stored on a computer connected to a network such as the Internet and provided by being downloaded via the network. In addition, a program for performing each processing executed by the vehicle display control device 20 according to the above embodiment may be provided or distributed via a network such as the Internet.

In addition, the program executed by the vehicle display control device 20 according to the above embodiment may be provided by being incorporated in the ROM 38 or the like in advance, or may be stored in the HDD 42.

While certain embodiments have been described, these embodiments have been presented by way of example only, and are not intended to limit the scope of the inventions. Indeed, the novel methods and systems described herein may be embodied in a variety of other forms, moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

Supplementary Description

As is apparent from the above embodiment, the present disclosure includes the following aspects. In the following, reference signs are given in parentheses only to clearly indicate the correspondence relation with the embodiment.

A vehicle display control device (20) according to a first aspect includes a regulation recognition unit (203), a regulation validity determination unit (205), and a display control unit (208). The regulation recognition unit (203) recognizes a traffic regulation mark indicating a traffic regulation provided on a traveling route of a host vehicle. The regulation validity determination unit (205) determines whether or not regulation content information is valid. The regulation content information is content of the regulation indicated by the traffic regulation mark recognized by the regulation recognition unit (203). The display control unit (208) controls a display device (22) mounted on the host vehicle to display the regulation content information in a display region. In a case where the regulation validity determination unit (205) determines that the regulation content information is not valid, the display control unit (208) changes the display mode of the regulation content information. According to the first aspect, in a case where the regulation content information is not valid, the regulation content information can be displayed in a display mode different from that in a case where the regulation content information is valid. Therefore, the driver can easily recognize that the regulation content information is not valid.

The vehicle display control device (20) according to a second aspect can be implemented by a combination with the first aspect. In the second aspect, the vehicle display control device (20) further includes a remaining amount identification unit (206). The remaining amount identification unit (206) identifies a remaining amount indicating at least one of a remaining traveling distance and a remaining traveling time required for the host vehicle to travel from a vehicle position of the host vehicle to an end of a regulation valid range. The display control unit (208) controls the display device to display, in the display region, remaining amount information indicating the remaining amount identified by the remaining amount identification unit (206) in addition to the regulation content information. The display control unit (208) changes a display mode of the remaining amount information in response to determining by the regulation validity determination unit that the regulation content information is not valid. According to the second aspect, in a case where the regulation content information is not valid, the remaining amount information can be displayed in a display mode different from that in a case where the regulation content information is valid. Therefore, the driver can more easily recognize that the regulation content information is not valid.

The vehicle display control device (20) according to a third aspect can be implemented by a combination with the first or second aspect. In the third aspect, in a case where the regulation validity determination unit (205) determines that the regulation content information is not valid, the display control unit (208) changes the display mode of the regulation content information to be different from a display mode of the regulation content information that has been determined as being valid by the regulation validity determination unit. According to the third aspect, the driver can more easily recognize that the regulation content information is not valid.

The vehicle display control device (20) according to a fourth aspect can be implemented by a combination with any one of the first to third aspects. In the fourth aspect, the vehicle display control device (20) further includes a first regulation identification unit (204). The first regulation identification unit (204) identifies a regulation target vehicle type on the basis of the traffic regulation mark recognized by the regulation recognition unit (203), the regulation target vehicle type being a vehicle type indicated as a regulation target by the traffic regulation mark. The regulation validity determination unit (205) determines whether or not the regulation content information is valid on the basis of vehicle data including at least one of a vehicle type, a weight, a height, and a length of the host vehicle and the regulation target vehicle type identified by the first regulation identification unit (204). According to the fourth aspect, in a case where the host vehicle does not correspond to the regulation target vehicle type, the regulation content information can be displayed in a display mode different from that in a case where the host vehicle corresponds to the regulation target vehicle type. Therefore, the driver can easily recognize that the host vehicle does not correspond to the regulation target vehicle type.

The vehicle display control device (20) according to a fifth aspect can be implemented by a combination with any one of the first to fourth aspects. In the fifth aspect, the vehicle display control device (20) further includes a second regulation identification unit (204). The second regulation identification unit (204) identifies a regulation application time, which is a date and time when the regulation is applied, indicated by the traffic regulation mark, on the basis of the traffic regulation mark recognized by the regulation recognition unit (203). The regulation validity determination unit (205) determines whether or not the regulation content information is valid on the basis of time data indicating a current date and time and the regulation application time identified by the second regulation identification unit (204). According to the fifth aspect, in a case where the current date and time does not correspond to the regulation application time, the regulation content information can be displayed in a display mode different from that in a case where the current date and time corresponds to the regulation application time. Therefore, the driver can easily recognize that the current date and time does not correspond to the regulation application time.

The vehicle display control device (20) according to a sixth aspect can be implemented by a combination with any one of the first to fifth aspects. In the sixth aspect, the vehicle display control device (20) further includes a priority setting unit (207). The priority setting unit (207) sets priority of the regulation content information. The display control unit (208) changes the display mode of the regulation content information on the basis of the priority set by the priority setting unit (207). According to the sixth aspect, the display mode of the regulation content information can be changed so that the regulation content information having a high priority becomes more conspicuous. Therefore, the driver can easily recognize the regulation content information having a high priority.

The vehicle display control device (20) according to a seventh aspect can be implemented by a combination with the sixth aspect. In the seventh aspect, the priority setting unit (207) places the lowest priority on the regulation content information that has been determined as being not valid by the regulation validity determination unit (205). According to the seventh aspect, the regulation content information that is not valid is displayed in a display mode corresponding to the lowest priority. Therefore, the driver can more easily recognize that the regulation content information is not valid.

The vehicle display control device (20) according to an eighth aspect can be implemented by a combination with the seventh aspect. In the eighth aspect, the display control unit (208) changes the display mode of the regulation content information on which the lowest priority has been placed by the priority setting unit (207) to be different from a display mode of the regulation content information on which the lowest priority has not been placed by the priority setting unit (207). According to the eighth aspect, the driver can more easily recognize that the regulation content information is not valid.

The vehicle display control device (20) according to a ninth aspect can be implemented by a combination with any one of the first to eighth aspects. In the ninth aspect, the display control unit (208) displays an image of a strikethrough line to superimpose on the regulation content information that has been determined as being not valid by the regulation validity determination unit (205). According to the ninth aspect, the driver can more easily recognize that the regulation content information is not valid.

The vehicle display control device (20) according to a tenth aspect can be implemented by a combination with the first to eighth aspects. In the tenth aspect, the display control unit (208) stops displaying the regulation content information that has been determined as being not valid by the regulation validity determination unit (205). According to the tenth aspect, the driver can more easily recognize that the regulation content information is not valid.

A vehicle display control method according to an eleventh aspect includes a regulation recognition step, a regulation validity determination step, and a display control step. In the regulation recognition step, a traffic regulation mark indicating a traffic regulation provided on a traveling route of a host vehicle is recognized. In the regulation validity determination step, whether or not regulation content information which is content of the regulation indicated by the traffic regulation mark recognized in the regulation recognition step is valid is determined. In the display control step, a display device (22) mounted on the host vehicle is controlled to display the regulation content information in a display region. In the display control step, the display mode of the regulation content information is changed in a case where it is determined in the regulation validity determination step that the regulation content information is not valid. According to the eleventh aspect, in a case where the regulation content information is not valid, the regulation content information can be displayed in a display mode different from that in a case where the regulation content information is valid. Therefore, the driver can easily recognize that the regulation content information is not valid.

The vehicle display control device according to the present disclosure is able to appropriately display the regulation content information.

What is claimed is:

1. A vehicle display control device comprising:
a hardware processor connected to a memory and configured to function as:
a regulation recognition unit to recognize a traffic regulation mark indicating a traffic regulation provided on a traveling route of a host vehicle;
a regulation validity determination unit to determine whether or not regulation content information is valid, the regulation content information being content of the regulation indicated by the traffic regulation mark recognized by the regulation recognition unit; and
a display controller to control a display device mounted on the host vehicle to display the regulation content information in a display region,
wherein the display controller changes a display mode of the regulation content information in response to determining by the regulation validity determination unit that the regulation content information is not valid.

2. The vehicle display control device according to claim 1, wherein
the hardware processor is further configured to function as a remaining amount identification unit to identify a remaining amount indicating at least one of a remaining traveling distance and a remaining traveling time required for the host vehicle to travel from a vehicle position of the host vehicle to an end of a regulation valid range being a valid range of the regulation indicated by the traffic regulation mark,
the display controller controls the display device to display, in the display region, remaining amount information indicating the remaining amount identified by the remaining amount identification unit in addition to the regulation content information, and
the display controller changes a display mode of the remaining amount information in response to determining by the regulation validity determination unit that the regulation content information is not valid.

3. The vehicle display control device according to claim 1, wherein, in response to determining by the regulation validity determination unit that the regulation content information is not valid, the display controller changes the display mode of the regulation content information to be different from a display mode of regulation content information having been determined as being valid by the regulation validity determination unit.

4. The vehicle display control device according to claim 1, wherein
the hardware processor is further configured to function as a first regulation identification unit to identify a regulation target vehicle type on the basis of the traffic regulation mark recognized by the regulation recognition unit, the regulation target vehicle type being a vehicle type indicated as a regulation target by the traffic regulation mark, and
the regulation validity determination unit determines whether or not the regulation content information is valid on the basis of vehicle data and the regulation target vehicle type, the vehicle data including at least one of a vehicle type, a weight, a height, and a length of the host vehicle.

5. The vehicle display control device according to claim 1, wherein
the hardware processor is further configured to function as a second regulation identification unit to identify a regulation application time on the basis of the traffic regulation mark recognized by the regulation recognition unit, the regulation application time being a date and time to which the regulation is applied and being indicated by the traffic regulation mark, and
the regulation validity determination unit determines whether or not the regulation content information is valid on the basis of time data indicating a current date and time and the regulation application time identified by the second regulation identification unit.

6. The vehicle display control device according to claim 1, wherein
the hardware processor is further configured to function as a priority setting unit to set priority of the regulation content information, and
the display controller changes the display mode of the regulation content information on the basis of the priority set by the priority setting unit.

7. The vehicle display control device according to claim 6, wherein the priority setting unit places the lowest priority on the regulation content information having been determined as being not valid by the regulation validity determination unit.

8. The vehicle display control device according to claim 7, wherein the display controller changes the display mode of the regulation content information on which the lowest priority has been placed by the priority setting unit to be different from a display mode of the regulation content information on which the lowest priority has not been placed by the priority setting unit.

9. The vehicle display control device according to claim 1, wherein the display controller displays an image of a strikethrough line to superimpose on the regulation content information having been determined as being not valid by the regulation validity determination unit.

10. The vehicle display control device according to claim 1, wherein the display controller stops displaying the regulation content information having been determined as being not valid by the regulation validity determination unit.

11. A vehicle display control method comprising:
recognizing a traffic regulation mark indicating a traffic regulation provided on a traveling route of a host vehicle;
determining whether or not regulation content information is valid, the regulation content information being content of the regulation indicated by the recognized traffic regulation mark; and
controlling a display device mounted on the host vehicle to display the regulation content information in a display region,
wherein the controlling of the display device includes changing a display mode of the regulation content information in response to determining by the determination that the regulation content information is not valid.
